(19) United States
(12) Patent Application Publication
(10) Pub. No.: US 2018/0293528 A1
(43) Pub. Date: Oct. 11, 2018

(54) TASK PLANNING USING TASK-EMOTIONAL STATE MAPPING

(71) Applicant: INTERNATIONAL BUSINESS MACHINES CORPORATION, ARMONK, NY (US)

(72) Inventors: JAMES E. BOSTICK, CEDAR PARK, TX (US); JOHN M. GANCI, JR., CARY, NC (US); MARTIN G. KEEN, CARY, TX (US); SARBAJIT K. RAKSHIT, KOLKATA (IN)

(73) Assignee: INTERNATIONAL BUSINESS MACHINES CORPORATION, ARMONK, NY (US)

(21) Appl. No.: 15/481,541

(22) Filed: Apr. 7, 2017

(51) Int. Cl. G06Q 10/06

(52) U.S. Cl. CPC G06Q 10/06316

(57) ABSTRACT

A present emotional state of a user is computed. Using a first task-state relationship, an evaluation is made that the present emotional state of the user is insufficient for a first task. A suggestion is made for performing a second task from a task list by the user under the present emotional state. A first future emotional state of the user at a first future time is forecasted. A determination is made that the first future emotional state of the user is sufficient for a third task from the task list. The task list is rearranged such that the third task occurs after the second task.

### TECHNICAL FIELD

The present invention relates generally to a method, system, and computer program product for determining a suitability of a user's emotional state for a task. More particularly, the present invention relates to a method, system, and computer program product for task planning using task-emotional state mapping.

### BACKGROUND

Humans (users) experience a wide range of emotions from time-to-time and day-to-day. A user's emotional state is an emotional condition of the user at any given time. Some non-limiting examples of emotional states include happy, upset, sad, frustrated, uplifted, depressed, nervous, and anxious.

A user may have to perform certain tasks, such as tasks at the user's job, at home, or in other settings or capacities. Different tasks require different degrees of attention, aptitude, and concentration. A user's emotional state affects the user's attention, aptitude, concentration, or some combination thereof.

Hereinafter, any reference to an emotional state of a user refers to any applicable human emotional state, unless expressly specified where used. A reference to an emotional state refers to a singular or discrete emotional state that can be determined or established with conclusive certainty, or a combination of several discrete emotional states each having a corresponding likelihood in the combination. Hereinafter, any reference to a task refers to any type of task a human user can be expected to perform in any capacity or setting, unless expressly specified where used.

### SUMMARY

The illustrative embodiments provide a method, system, and computer program product. An embodiment includes a method that computes, using a processor and a memory, a present emotional state of a user. The embodiment evaluates, using a first task-state relationship, that the present emotional state of the user is insufficient for a first task. The embodiment suggests performing a second task from a task list by the user under the present emotional state. The embodiment forecasts a first future emotional state of the user at a first future time. The embodiment determines that the first future emotional state of the user is sufficient for a third task from the task list. The embodiment rearranges the task list such that the third task occurs after the second task.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for task planning using task-emotional state mapping in accordance with an illustrative embodiment;

FIG. 4 depicts a block diagram of a manner of rearranging and suggesting tasks in accordance with an illustrative embodiment;

FIG. 5A depicts an example notification in accordance with an illustrative embodiment;

FIG. 5B depicts another example notification in accordance with an illustrative embodiment;

FIG. 5C depicts another example notification in accordance with an illustrative embodiment; and

FIG. 6 depicts a flowchart of an example process for task planning using task-emotional state mapping in accordance with an illustrative embodiment.

### DETAILED DESCRIPTION

Presently, solutions are available to measure a user's physical state, such as sleepy or intoxicated, and to determine whether the user's physical state is suitable for performing certain tasks, such as operating an automobile. The illustrative embodiments recognize that performing a given task is also significantly dependent upon the emotional state of the user. For example, even a non-intoxicated and wide-awake user may not be able to operate an automobile under certain emotional states, such as extreme nervousness or agitation.

More broadly, just about every task, from mundane to highly skilled ones, has some desirable emotional state under which the task should be performed for optimal results. Or conversely, just about every task has some undesirable emotional states under which performing the task can result in sub-optimal results.

The illustrative embodiments recognize that determining the emotional state of a user and determining the suitability of that state for a task with which the user is either currently engaged or is about to engage is a complex and highly nuanced problem. For example, the illustrative embodiments recognize that an emotional state is actually a complex relationship of a number of variables affecting the user, exhibited by the user, or both. Furthermore, determining the emotional state from a set of variables is probabilistic such that for the same set of variable values, different emotional states are possible up to different probabilities for different users.

Similarly, a task can have an emotional profile, which can include one or more emotional states. The one or more emotional states can participate up to different extents, and with different tolerances and relevance in a task's emotional profile.

Such participation means, the illustrative embodiments recognize, that different variables of the task and different variables of a user's emotional state act in a complex user-specific relationship in determining a suitability of a specific combination of specific probable emotional states of a specific user for a specific task at a specific time.

The illustrative embodiments recognize that determining the suitability of a user's emotional state for a planned or current task is a complex problem. The illustrative embodiments further recognize that the emotional state of a user is non-static or dynamic, i.e., changing over time. The dynamic nature of the emotional state is significantly affected by the environment of the user and the activities of the user.

While it may be difficult to control the environment of the user, the illustrative embodiments recognize that the activities of the user can be adjusted such that a future emotional state likely to be reached by the user at a future time can be forecasted. Accordingly, the illustrative embodiments recognize that re-arranging a user's planned activities according to a present emotional state of the user, and one or more forecasted emotional states of the user at one or more corresponding future times will be useful. For example, from a list of tasks, the user can be guided or suggested a first task that is most suitable according to a present emotional state of the user; the performance of the first task can be used to forecast a second emotional state reached by the user at a second time; a second task can be identified from the list for which the second emotional state would be suitable; and the second task can be arranged to be performed at the second time while the user is in the forecasted second emotional state. Thus, the permission to perform a task can be denied if the emotional state is prohibitive for that task at the time of the performance, tasks on a plan can be rearranged to match suitable emotional states existing at different times, or both.

The illustrative embodiments recognize that the presently available tools or solutions do not address these needs or provide adequate solutions for these needs. The illustrative embodiments used to describe the invention generally address and solve the above-described problems and other problems related to task planning using task-emotional state mapping.

An embodiment can be implemented as a software application. The application implementing an embodiment can be configured as a modification of an existing task planning system—i.e., a native application in the task planning system, as an application executing in a data processing system communicating with an existing task planning system over a local area network (LAN)—i.e., a local application on the LAN, as an application executing in a data processing system communicating with an existing task planning system over a wide area network (WAN)—i.e., a remote application on the WAN, as a separate application that operates in conjunction with an existing task planning system, a standalone application, or some combination thereof.

A set of sensors is deployed and disposed suitably to collect biometric and other types of data from a user that are usable in determining the user's emotional state. For example, one example biometric sensor may measure changes in skin conductivity. A user may tend to perspire more—thereby increasing the skin conductivity—when the user is experiencing an upset emotion, a nervousness emotion, or a fright emotion. Similarly, another biometric sensor may pick up and measure tremors or slight incoordination in motor activity, which can result from being upset or agitated. A camera may capture a facial expression, which may reveal a happy or sad emotion. A microphone may pick up utterances that may be indicative of frustration, anger, or nervousness.

These examples of sensors, biometric and other measurements, and corresponding emotional states are not intended to be limiting. From this disclosure, those of ordinary skill in the art will be able to conceive many other sensors, biometric and other measurements, and corresponding emotional states and the same are contemplated within the scope of the illustrative embodiments.

An embodiment receives the sensor data collected from the set of sensors disposed relative to a user. The embodiment, using one or more algorithms or learning-capable networks—such as artificial neural networks, computes one or more likely emotional states experienced by the user with corresponding degrees of likelihoods or probability. The likelihood of an emotional state, in a combination of emotional states, can be expressed in any suitable manner, including but not limited to a value on a range scale—e.g., scale of 0 to 5. A reference to an emotional state refers to a singular emotional state determined with conclusive certainty, or a combination of states each having a corresponding likelihood.

For example, if the user is only exhibiting heightened perspiration, the user could be frightened, nervous, or upset with equal likelihood. But if the user is also experiencing tremors, the likelihood that the user is experiencing an upset experience is greater than the likelihood of the nervousness or fright emotion.

These simplified examples of computing one or more emotional states and corresponding likelihoods are not intended to be limiting. From this disclosure, those of ordinary skill in the art will be able to conceive many other more realistic and complex computations of emotional states and corresponding likelihoods, and the same are contemplated within the scope of the illustrative embodiments.

An embodiment detects a current task being performed or selected by the user, or a task that is planned to be performed according to a list of tasks, while the user is in the emotional state. The embodiment determines whether the user's emotional state is suitable for permitting the user to proceed with the task. For determining the suitability, the embodiment uses a user-specific task-state relationship based on historical emotional state data of the user and the performance data of the tasks performed by the user under various emotional states.

Stated another way, a repository collects and maintains the emotional state data of a user along with the user's performance or task results data from a variety of tasks that were performed by the user while in a variety of emotional states. Thus, for a specific user, one or more relationships between one or more task performances and one or more emotional states of the user (task-state relationships) are constructed and stored in a repository.

For example, suppose that an embodiment is configured to calculate a combination of six emotional states (states A, B, C, D, E, F) on a likelihood scale of 0-5 using available sensor data. A user's present emotional state may be A=0, B=5, C=3, D=0, E=0, and F=1, notated for the purposes of these example states (A,B,C,D,E,F) as (0,5,3,0,0,1). Suppose that historically, the same user has performed one task (T1) satisfactorily when the emotional state of the user has been at least (4,4,4,4,1,1), and the same user has performed another task (T2) satisfactorily when the emotional state of the user has been at least (0,3,3,X,X,1). X represents that a particular emotional state is irrelevant to the task. In a simple example case, the tolerance function may be defined as “specified likelihood or better or all specified states.” Accordingly, in such an example case and using such an example tolerance function, the user's emotional state (0,5,3,0,0,1) is suitable for task T2 but not for task T1.

Suppose the user has an example task list of T1 followed by T2. Accordingly, if the user was attempting to perform task T1, an embodiment denies the user permission for T1 and suggests performing T2 instead. In other words, the embodiment rearranges the tasks on the list such that T2 is performed before T1. Any number of tasks can similarly be evaluated and rearranged in a list of tasks.

An embodiment further forecasts a future emotional state after a particular task will be completed. For example, the embodiment determines the emotional state of the user after the user will have completed task T2 at a future time. The embodiment determines a suitability of the forecasted emotional state for another planned task, such as task T1. The embodiment arranges the tasks such that each next task has a user-specific emotional profile that matches the emotional state the user is expected to reach from performing a previous task and prior to performing that next task. The embodiment suggests tasks from the list at different times according to the suitability of those tasks given the user's actual measured emotional state or a forecasted emotional state at the time.

Suppose in the above example, after the user has performed T2, the user's emotional state is forecasted to be (4,5,4,4,4,2). This state is suitable for Task T1 but not for T3 (5,5,5,0,0,X). Accordingly, the embodiment arranges task T1 after T2 but not T3 after T2. T3 may be suggested if the user's emotional state after performing T1 is sufficient for the performance of T3.

The manner of task planning using task-emotional state mapping described herein is unavailable in the presently available methods. A method of an embodiment described herein, when implemented to execute on a device or data processing system, comprises substantial advancement of the functionality of that device or data processing system in optimally rearranging tasks on a tasks list such that a user's present and forecasted emotional states are sufficient or suitable for performing those tasks at forecasted times of reaching the forecasted emotional states.

The illustrative embodiments are described with respect to certain types of biometric measurements, sensors, emotional states, likelihoods, combinations, tolerance functions, arrangement orders, forecasts of emotional states and times, permissions, denials, authorizations, suggestions, relationships, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

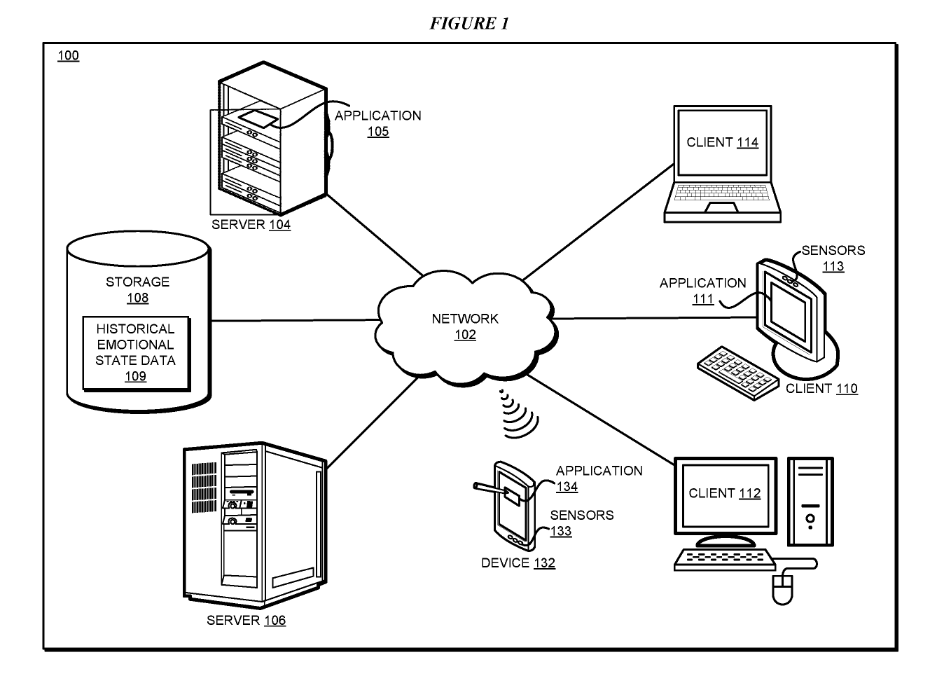

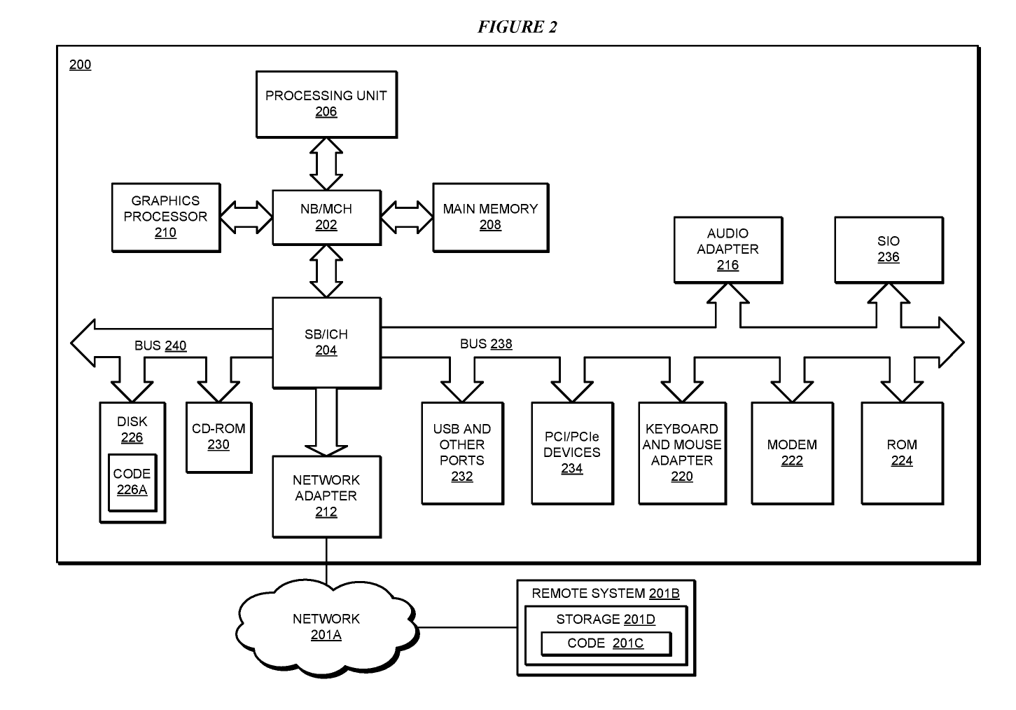

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements a remotely usable function (remote) of an embodiment described herein. Application 111 implements a locally usable function (local) or a natively usable function (native) of an embodiment described herein. Application 134 implements a natively usable function (native) of an embodiment described herein. Applications 105 and 111 can be used in a combination, applications 105 and 134 can be used in another combination, and applications 105, 111, and 134 can be used in another combination, to distribute certain functions of an embodiment. When client 110 is used by the user, sensors 113 measure biometric indicators and provide sensor data of those biometric measurements to application 111, application 105, or both, as the specific implementation case may be. Similarly, when the user uses device 132, sensors 133 provide the sensor data to application 134, application 105, or both, as the specific implementation case may be. Historical data 109 includes the historical emotional state data of the user and one or more user-specific task-state relationships for one or more users, their one or more emotional states, and one or more tasks that they each have performed in the past.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105, 111, and 134 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

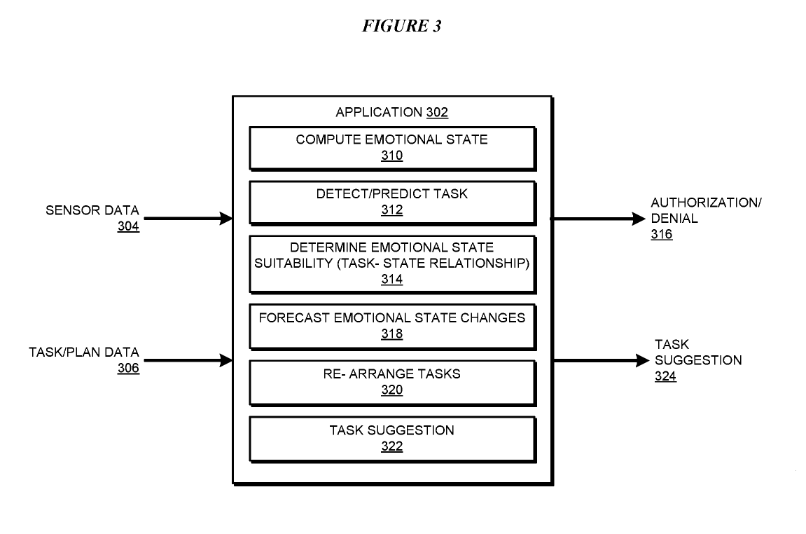

With reference to FIG. 3, this figure depicts a block diagram of an example configuration for task planning using task-emotional state mapping in accordance with an illustrative embodiment. Application 302 is an example of application 105, 111, or 134, or some combination thereof, in FIG. 1.

Input 304 includes sensor data from one or more sensors. Input 306 includes a task list or some suitable organization of one or more tasks that the user is either currently performing, is currently attempting to perform, or is planning to perform at a future time.

Component 310 uses sensor data input 304 to compute an emotional state of the user. Component 310 identifies one or more likely emotional states from analyzing sensor data 304, and computes the likelihood of each of those one or more emotional states.

Component 312 uses task data input 306 to determine, detect, or predict a task that the user is performing or attempting to perform at the time sensor data 304 was measured. Component 314 determines the suitability of the emotional state of the user, as computed by component 310, for the task identified by component 312. When the emotional state of the user is unsuitable for that task, component 314 outputs permission 316 in the form of a denial of permission to perform that task. When the emotional state of the user is suitable for that task, component 314 outputs permission 316 in the form of an authorization to perform that task. In one embodiment, the determination of the suitability uses one or more tolerance functions, as described herein.

Component 318 forecasts a future emotional state of the user at a future time. The forecasted emotional state may be based on present-time emotional state according to sensor data 304, an emotional state change resulting from a task to be performed prior to the future time, or a combination thereof.

Component 320 rearranges the tasks on a task list received in task data 306. Particularly, component 320 uses the forecasted emotional states at one or more future times to select tasks suitable for performing with those forecasted emotional states at those one or more future times.

Component 322 provides suggestion 324 to the user. Suggestion 324 can take the form of a notification, recommendation, or a suggestion, and can be delivered in any suitable manner. When suggestion 324 applies to a present-time task selection, suggestion 324 suggests a task from task data 306, which is suitable under the present-time emotional state according to present-time sensor data 304. When suggestion 324 applies to a future task selection, suggestion 324 suggests a task from task data 306, which is suitable under the forecasted future emotional state at a future time.

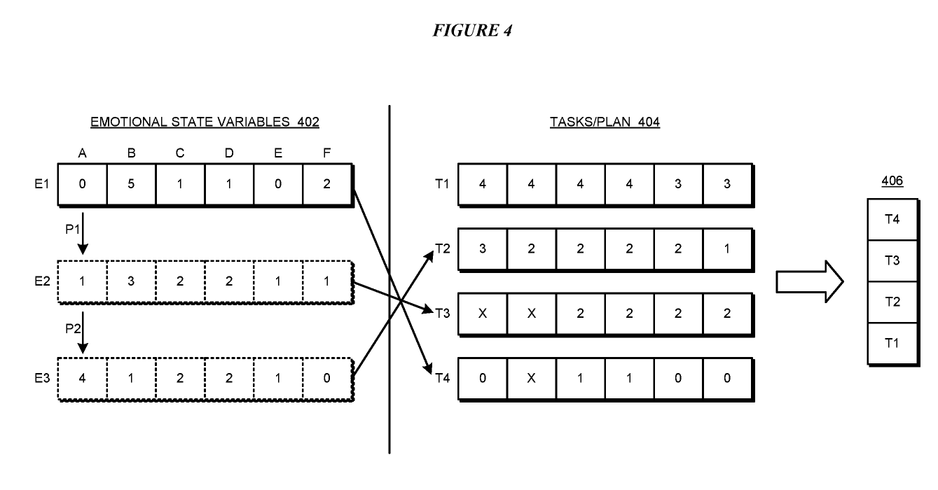

With reference to FIG. 4, this figure depicts a block diagram of a manner of rearranging and suggesting tasks in accordance with an illustrative embodiment. Application 302 in FIG. 3 performs the depicted rearranging and suggesting.

Column 402 depicts certain example emotional states of a user. Column 404 depicts certain example tasks on a given task list, and the emotional state profiles of the various example tasks. Again, only for the clarity of the description, some example non-limiting simple tolerance or suitability functions (task-state relationship) are described and used.

Suppose that six example emotional states (A,B,C,D,E,F) are computed in a combination emotional state of the user. Suppose that the present emotional state of the user is state E1 (0,5,1,1,0,2). The task list according to column 404 includes tasks T1, T2, T3, and T4, arranged in that order. Task T1 has an emotional profile of (4,4,4,4,3,3) and a task-state relationship for this user which specifies that [each individual emotional state must have the specified likelihood or better] for the combination emotional state to be suitable for T1. Task T2 has an emotional profile of (3,2,2,2,2,1) and a task-state relationship for this user which specifies that [emotional states A C and D must have the specified likelihood or better, and emotional states B E and F cannot be more than 1 different from the specified likelihood] for the combination emotional state to be suitable for T2. Task T3 has an emotional profile of (X,X,2,2,2,2) and a task-state relationship for this user which specifies that [emotional states A and B are irrelevant, emotional states C and D must have the specified likelihood or better, and emotional states E and F cannot be more than 1 different from the specified likelihood] for the combination emotional state to be suitable for T3. Task T4 has an emotional profile of (0,X,1,1,0,0) and a task-state relationship for this user which specifies that [emotional state B is irrelevant, emotional states A C D E and F must have the specified likelihood or better] for the combination emotional state to be suitable for T4.

Given this example task-state relationship setup for the particular user, application 302 computes the suitability of present-time emotional state E1 for any of tasks T1-T4. The application finds that the user should not perform task T1 as listed but the user's emotional state E1 is presently suitable for task T4.

The application forecasts that after period P1, e.g., when T4 is completely or partially completed, the user will likely be in emotional state E2 (1,3,2,2,1,1). The application computes that the suitability of future emotional state E2, at a future time after P1, is going to be suitable for task T3.

The application forecasts that after further period P2, e.g., when T3 is completely or partially completed, the user will likely be in emotional state E3 (4,1,2,2,1,0). The application computes that the suitability of future emotional state E3, at a future time after P1+P2, is going to be suitable for task T2.

Accordingly, the application outputs rearranged task list 406. Task list 406 suggests performing task T4, followed by T3, followed by T2, as described above. Task T1 can be placed after T3 or omitted from list 406. According to one embodiment, the application receives updates sensor data 304 after periods P1 and P2 to compute the actual emotional states reached by the user. Whether and when T1 should be performed can be adjusted according to the ongoing sensor measurements, some logic or rule, or some combination thereof.

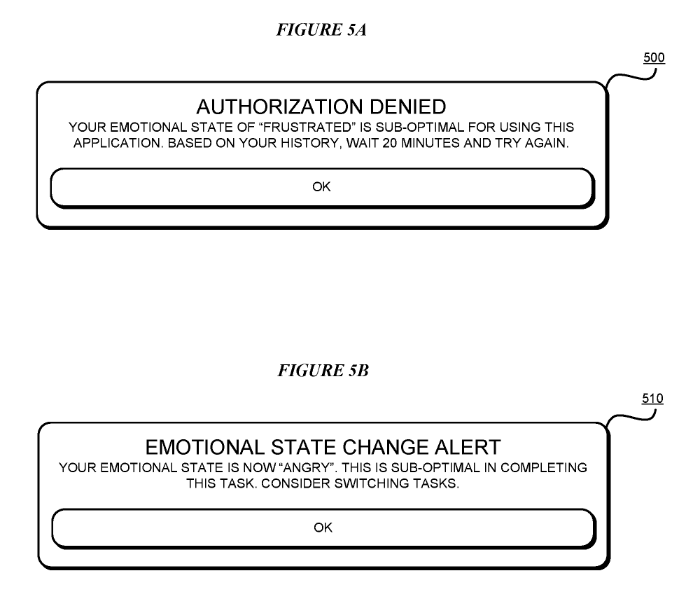

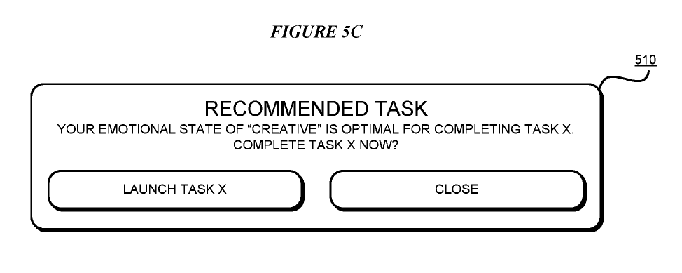

With reference to FIG. 5A, this figure depicts an example notification in accordance with an illustrative embodiment. Application 302 in FIG. 3 may produce notification 500 as output 316 in FIG. 3. Notification 500 denies the authorization to proceed with a task when the task-state relationship for a particular task and a particular emotional state of a particular user indicates that the particular emotional state of the particular user is unsuitable for the particular task.

With reference to FIG. 5B, this figure depicts another example notification in accordance with an illustrative embodiment. Application 302 in FIG. 3 may produce notification 510 as output 316 in FIG. 3. Notification 510 alerts the user of a changing emotional state and provides a suggestion of an alternate task that can be performed instead of a previously planned task. For example, an ongoing measurement of the user biometrics may reveal a change in the user's emotional state. As another example, the application may forecast a change in the emotional state of the user based on the received sensor data, received environment data about the user's environmental factors, user's performance data from the performance of a previous or ongoing task, or some combination thereof. In the depicted example, notification 510 notifies the user that the task-state relationship for a particular task and a particular emotional state of a particular user indicates that the particular emotional state of the particular user is unsuitable for the particular task and the user should switch to a suggested alternative task.

With reference to FIG. 5C, this figure depicts another example notification in accordance with an illustrative embodiment. Application 302 in FIG. 3 may produce notification 520 as output 316 in FIG. 3. Notification 520 recommends a task to the user based on of a changed emotional state that is desirable for some other task. For example, an ongoing measurement of the user biometrics may reveal a change in the user's emotional state. As another example, the application may forecast a change in the emotional state of the user based on the received sensor data, received environment data about the user's environmental factors, user's performance data from the performance of a previous or ongoing task, or some combination thereof. In the depicted example, notification 520 notifies the user that the task-state relationship for a particular task and a particular emotional state of a particular user indicates that the particular emotional state of the particular user is suitable for the particular task and the user should switch to that particular task. The suggested task may be initiated from notification 520.

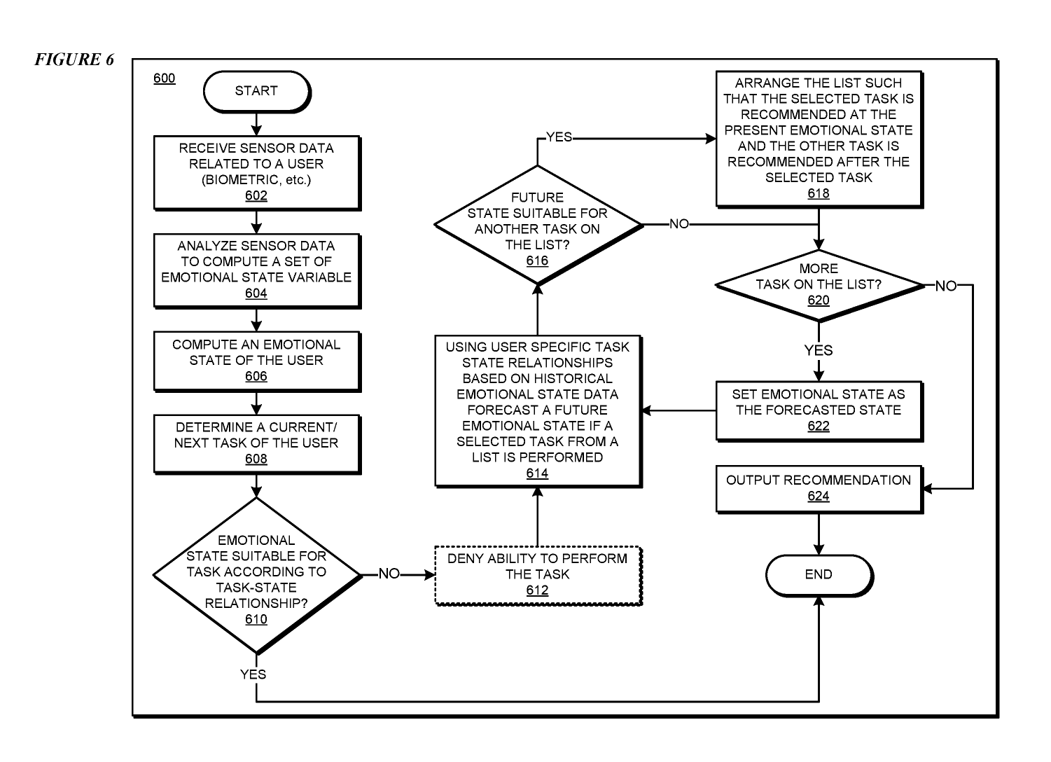

With reference to FIG. 6, this figure depicts a flowchart of an example process for task planning using task-emotional state mapping in accordance with an illustrative embodiment. Process 600 can be implemented using application 302 in FIG. 3.

The application receives sensor data of a user (block 602). The application analyzes the sensor data and computes a set of emotional state variables from the sensor data (block 604). The application computes a singular emotional state or a combination emotional state from the emotional state variables (block 606).

The application determines a current or planned task of the user (block 608). The task may be a part of a task list.

The application determines whether the emotional state computed in block 606 is suitable for the task determined in block 608 according to a user-specific task-state relationship (block 610). If the emotional state of the user is suitable (“Yes” path of block 610), the application either ends process 600 or proceeds to block 614.

If the emotional state of the user is unsuitable (“No” path of block 610), the application optionally denies the user the ability to perform that task (block 612). At block 612, the application may also suggest and/or allow the user to perform a different task from the list.

The application, using a set of user-specific task-state relationships that are based on historical emotional state data of the user and the tasks performed by the user, forecasts a future emotional state of the user if a selected task from the task list is performed (block 614).

The application determines whether the forecasted future emotional state is suitable for another task in the task list (block 616). If the forecasted future emotional state is unsuitable for another task (“No” path of block 616), the application proceeds to block 620. If the forecasted future emotional state is suitable for another task (“Yes” path of block 616), the application arranges the task list such that the selected task is recommended at the present emotional state and the other task is recommended as the next task after the present task (block 618).

The application determines whether more tasks exist on the list for rearranging (block 620). If more tasks exist for the rearranging (“Yes” path of block 620), the application sets the user's emotional state as the forecasted state for rearranging purposes (block 622). The application then returns process 600 to block 614.

If no more tasks exist for rearranging (“No” path of block 620), the application outputs the recommended tasks order (block 624). The application ends process 600 thereafter.

Thus, a computer implemented method, system or apparatus, and computer program product are provided in the illustrative embodiments for task planning using task-emotional state mapping and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
computing, using a processor and a memory, a present emotional state of a user;
evaluating, using a first task-state relationship, that the present emotional state of the user is insufficient for a first task;
suggesting performing a second task from a task list by the user under the present emotional state;
forecasting a first future emotional state of the user at a first future time;
determining that the first future emotional state of the user is sufficient for a third task from the task list; and
rearranging the task list such that the third task occurs after the second task.

2. The method of claim 1, further comprising:
forecasting a second future emotional state of the user at a second future time;
determining that the second future emotional state of the user is sufficient for a fourth task from the task list; and
rearranging the task list such that the fourth task occurs after the third task.

3. The method of claim 1, wherein the first future time occurs when the second task is expected to be completed.

4. The method of claim 1, wherein the first future time occurs when the second task is expected to be partially completed.

5. The method of claim 1, further comprising:
computing a second emotional state of the user using updated sensor data of the user;
computing, at substantially the first future time, a difference between the second emotional state and the first future emotional state; and
adjusting the rearranging according to the difference.

6. The method of claim 5, further comprising:
replacing, as a part of the adjusting, the third task with a fourth task, wherein the fourth task is suitable for the user under the second emotional state according to a fourth task-state relationship corresponding to the fourth task and the user.

7. The method of claim 1, further comprising:
constructing, using a first historical emotional state data of the user and a first performance data of a previous performance of the first task by the user, the first task-state relationship, wherein the first task-state relationship is specific to the user and the first task.

8. The method of claim 7, further comprising:
constructing, using a second historical emotional state data of a second user and a first performance data of a previous performance of the first task by the second user, a second task-state relationship, wherein the second task-state relationship is specific to the second user and the first task.

9. The method of claim 1, further comprising:
receiving sensor data from a set of biometric sensors;
computing a set of emotional state variables from the sensor data; and
computing the emotional state from the set of emotional state variables.

10. The method of claim 9, wherein the sensor data comprises data output of a sensor that measures skin conductivity of the user.

11. The method of claim 9, wherein the sensor data comprises data output of an imaging device that captures a facial expression of the user.

12. The method of claim 9, wherein the sensor data comprises data output of a sensor that measures a tremor in a motion of the user.

13. The method of claim 1, wherein the emotional state comprises a singular emotional state.

14. The method of claim 1, wherein the emotional state comprises a combination of a plurality of discrete emotional states, each discrete emotional state in the plurality of emotional states having a corresponding likelihood.

15. A computer usable program product comprising one or more computer-readable storage devices, and program instructions stored on at least one of the one or more storage devices, the stored program instructions comprising:
program instructions to compute, using a processor and a memory, a present emotional state of a user;
program instructions to evaluate, using a first task-state relationship, that the present emotional state of the user is insufficient for a first task;
program instructions to suggest performing a second task from a task list by the user under the present emotional state;
program instructions to forecast a first future emotional state of the user at a first future time;
program instructions to determine that the first future emotional state of the user is sufficient for a third task from the task list; and
program instructions to rearrange the task list such that the third task occurs after the second task.

16. The computer usable program product of claim 15, further comprising:
program instructions to forecast a second future emotional state of the user at a second future time;
program instructions to determine that the second future emotional state of the user is sufficient for a fourth task from the task list; and
program instructions to rearrange the task list such that the fourth task occurs after the third task.

17. The computer usable program product of claim 15, wherein the first future time occurs when the second task is expected to be completed.

18. The computer usable program product of claim 15, wherein the computer usable code is stored in a computer readable storage device in a data processing system, and wherein the computer usable code is transferred over a network from a remote data processing system.

19. The computer usable program product of claim 15, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to compute a present emotional state of a user;
program instructions to evaluate, using a first task-state relationship, that the present emotional state of the user is insufficient for a first task;
program instructions to suggest performing a second task from a task list by the user under the present emotional state;
program instructions to forecast a first future emotional state of the user at a first future time;
program instructions to determine that the first future emotional state of the user is sufficient for a third task from the task list; and
program instructions to rearrange the task list such that the third task occurs after the second task.
